(19) United States
(12) Patent Application Publication
(10) Pub. No.: US 2026/0351569 A1
(43) Pub. Date: Nov. 5, 2026

(54) POSITIVE ELECTRODE PLATE AND NON-AQUEOUS ELECTROLYTE SECONDARY BATTERY HAVING THE SAME

(71) Applicant: Prime Planet Energy & Solutions, Inc., Tokyo (JP)

(72) Inventors: Ryo HANAZAKI, Kobe-shi, Hyogo (JP); Kouhei MASAI, Kobe-shi, Hyogo (JP)

(21) Appl. No.: 19/096,720

(22) Filed: Apr. 1, 2025

(30) Foreign Application Priority Data
Apr. 15, 2024 (JP) 2024-065634

(51) Int. Cl. H01M 4/36; H01M 4/02; H01M 4/131; H01M 4/505; H01M 4/525

(52) U.S. Cl. CPC H01M 4/366; H01M 4/131; H01M 4/505; H01M 4/525; H01M 2004/021; H01M 2004/028

(57) ABSTRACT

A positive electrode plate comprises a current collector, and an active material layer provided on the current collector. The active material layer has a first layer mainly composed of a first active material represented by a formula (I), and a second layer that is positioned closer to the current collector than the first layer is and that is mainly composed of a second active material represented by a formula (II). The formula (I) and the formula (II) are as specified in the claims. A porosity of the first layer and a porosity of the second layer are both 22% or less. A thickness of the first layer is smaller than a thickness of the second layer.

### CROSS REFERENCE TO RELATED APPLICATIONS

This nonprovisional application is based on Japanese Patent Application No. 2024-065634 filed on Apr. 15, 2024, with the Japan Patent Office, the entire contents of which are hereby incorporated by reference.

### BACKGROUND OF THE INVENTION

### Field of the Invention

The present invention relates to a positive electrode plate and a non-aqueous electrolyte secondary battery having the same.

### Description of the Background Art

It is known to use a positive electrode plate comprising a lithium-(transition metal) composite oxide as a positive electrode active material, on a current collector in a secondary battery. Japanese Patent Laying-Open No. 2015-115244 discloses a positive electrode for a secondary battery, comprising two layers that are different in the molar ratio of lithium to transition metal.

### SUMMARY OF THE INVENTION

From the viewpoint of enhancing the capacity of a secondary battery, it is desirable that the density of the active material layer of the positive electrode plate be high. However, when the density of the active material layer of the positive electrode plate is high, the porosity of the active material layer is low, and thereby quick-charge performance of the secondary battery can be low.

The present disclosure aims at providing a positive electrode plate that is capable of producing a non-aqueous electrolyte secondary battery with excellent quick-charge performance even when the active material layer has a low porosity, as well as a non-aqueous electrolyte secondary battery having the same.

[1] A positive electrode plate comprising:
a current collector; and
an active material layer provided on the current collector, wherein
the active material layer has
   a first layer mainly composed of a first active material represented by a formula (I) below, and
   a second layer that is positioned closer to the current collector than the first layer is and that is mainly composed of a second active material represented by a formula (II) below,
a porosity of the first layer and a porosity of the second layer are both 22% or less, and
a thickness of the first layer is smaller than a thickness of the second layer:

Li(Liₐ₁Niₓ₁Mn_{y1}M1_{z1})O₂ (I)

Li(Liₐ₂Niₓ₂Mn_{y2}M2_{z2})O₂ (II)
where
M1 and M2 are independently one or more metallic elements selected from the group consisting of Co, Al, Mg, Ca, Ti, V, Cr, Fe, Cu, Zn, Zr, Nb, Mo, Ta, and W,
0.1≤a1≤0.33, 0≤x1≤0.5, 0.5≤y1≤0.7, 0≤z1≤0.2, and a1+x1+y1+z1=1 are satisfied, and
−0.1≤a2≤0.1, 0.6≤x2≤1, 0≤y2≤0.3, 0≤z2≤0.3, and a2+x2+y2+z2=1 are satisfied.

[2] The positive electrode plate according to [1], wherein a thickness ratio of the first layer to the second layer is (first layer):(second layer)=0.8:9.2 to 4.5:5.5.

[3] The positive electrode plate according to [1] or [2], wherein a thickness ratio of the first layer to the second layer is (first layer):(second layer)=1:9 to 3.5:6.5.

[4] The positive electrode plate according to any one of [1] to [3], wherein a thickness of the active material layer is from 10 to 200 μm.

[5] The positive electrode plate according to any one of [1] to [4], wherein the porosity of the first layer and the porosity of the second layer are both 10 to 22%.

[6] The positive electrode plate according to any one of [1] to [5], wherein the first layer constitutes a surface of the active material layer on a side opposite to a side on which the current collector is positioned.

[7] The positive electrode plate according to any one of [1] to [6], wherein the second layer is in contact with the current collector.

[8] A non-aqueous electrolyte secondary battery comprising the positive electrode plate according to any one of [1] to [7].

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view schematically illustrating an example of a positive electrode plate according to an embodiment.

### DESCRIPTION OF THE PREFERRED EMBODIMENTS

Herein, a numerical range such as “from x to y” includes the upper limit and the lower limit, unless otherwise specified. That is, “from x to y” means a numerical range of “not less than x and not more than y”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

### (Positive Electrode Plate)

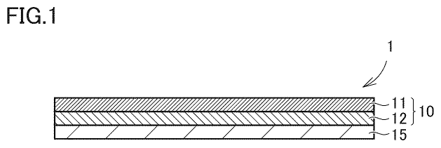

FIG. 1 is a cross-sectional view schematically illustrating an example of a positive electrode plate according to an embodiment. The positive electrode plate according to the present embodiment is used in a non-aqueous electrolyte secondary battery (hereinafter also called “a secondary battery”) such as a lithium-ion battery.

A positive electrode plate 1 has a current collector 15, and an active material layer 10 provided on current collector 15. Active material layer 10 has a first layer 11 mainly composed of a first active material represented by a formula (I) below, and a second layer 12 mainly composed of a second active material represented by a formula (II) below. Second layer 12 is positioned closer to current collector 15 than first layer 11 is. The porosity of first layer 11 and the porosity of second layer 12 are both 22% or less. The thickness of first layer 11 is smaller than the thickness of second layer 12.

Li(Liₐ₁Niₓ₁Mn_{y1}M1_{z1})O₂ (I)

Li(Liₐ₂Niₓ₂Mn_{y2}M2_{z2})O₂ (II)

[In the formula (I) and the formula (II),
M1 and M2 are independently one or more metallic elements selected from the group consisting of Co, Al, Mg, Ca, Ti, V, Cr, Fe, Cu, Zn, Zr, Nb, Mo, Ta, and W,
0.1≤a1≤0.33, 0≤x1≤0.5, 0.5≤y1≤0.7, 0≤z1≤0.2, and a1+x1+y1+z1=1 are satisfied, and
−0.1≤a2≤0.1, 0.6≤x2≤1, 0≤y2≤0.3, 0≤z2≤0.3, and a2+x2+y2+z2=1 are satisfied.]

Each of the first active material and the second active material is a lithium-(transition metal) composite oxide. The first active material is a lithium-rich positive electrode active material with a high Li content. As compared to the second active material, the first active material tends to provide high capacity but also has less Li diffusivity in a solid body. As compared to the first active material, the second active material has a low Li content so it has low capacity, but it has excellent Li diffusivity in a solid body. Having first layer 11 mainly composed of the first active material as well as second layer 12 mainly composed of the second active material, positive electrode plate 1 tends to provide a secondary battery with high capacity and good Li diffusivity in a solid body.

In positive electrode plate 1, the porosity of first layer 11 and the porosity of second layer 12 are both 22% or less, and thereby the secondary battery can have even higher capacity. However, because the first active material has low Li diffusivity in a solid body, when the porosity of first layer 11 and the porosity of second layer 12 are both low, the reaction that occurs during charging of the secondary battery tends not to occur throughout the entire first layer 11, and as a result, quick-charge performance tends to be low. In positive electrode plate 1, first layer 11 constitutes one of the surfaces of active material layer 10 which is farther from current collector 15 than second layer 12 is (hereinafter, this surface is also called “a side of active material layer 10 opposite to the current collector”). Because of this positioning, inside a secondary battery that has positive electrode plate 1, the first active material with less Li diffusivity in a solid body tends to come into contact with the electrolyte solution, and thereby quick-charge performance tends to be enhanced. Furthermore, because first layer 11 is thinner than second layer 12, the entire first layer 11 tends to come into contact with the electrolyte solution, and also, second layer 12 positioned on the current collector 15 side of active material layer 10 tends to come into contact with the electrolyte solution as well. As a result, concentration of reaction to the surface of first layer 11 (which is positioned on a side of active material layer 10 opposite to the current collector) during charging of the secondary battery tends to be reduced, and the reaction tends to proceed throughout the entire first layer 11 and also at second layer 12 which is positioned on the current collector 15 side. Because positive electrode plate 1 has this structure in which the reaction tends to proceed uniformly throughout the entire active material layer 10, a secondary battery having positive electrode plate 1 has excellent quick-charge performance.

Current collector 15 is a metal foil sheet that is formed with an aluminum material such as aluminum and aluminum alloy, for example.

Active material layer 10 is formed on current collector 15, and includes a positive electrode active material such as the first active material and the second active material. Active material layer 10 may be formed on only one side of current collector 15, or may be formed on both sides. In addition to the positive electrode active material, active material layer 10 includes at least one of a conductive aid and a binder, preferably both a conductive aid and a binder.

The first active material is simply required to be a compound represented by the above-mentioned formula (I). In the formula (I), M1 may include one or more types selected from the group consisting of Co, Al, Mg, Ti, Nb, and Mo, and preferably, it includes Co. In the formula (I), a1 may be 0.11≤a1≤0.3, or may be 0.11≤a1≤0.25, or may be 0.12≤a1≤0.20. In the formula (I), x1 may be 0<x1≤0.4, or may be 0.1≤x1≤0.4, or may be 0.2≤x1≤0.3. In the formula (I), y1 may be 0.50≤y1≤0.65, or may be 0.52≤y1≤0.60, or may be 0.55≤y1≤0.60. In the formula (I), z1 may be 0<z1≤0.2, or may be 0.05≤z1≤0.18, or may be 0.08≤z1≤0.15. The composition of the first active material can be determined by ICP (high-frequency Inductively Coupled Plasma) emission spectroscopy, for example.

The first active material may include two or more lithium-(transition metal) composite oxides that are different in composition, within the range of the composition represented by the formula (I). The first active material may include two or more lithium-(transition metal) composite oxides that are different in at least one of particle shape and particle size.

The second active material is simply required to be a compound represented by the above-mentioned formula (II). In the formula (II), M2 may include one or more types selected from the group consisting of Co, Al, Mg, Ti, Nb, and Mo, and preferably, it includes Co. In the formula (II), a2 may be −0.05≤a2≤0.05, or may be −0.03≤a2≤0.03, or may be −0.02≤a2≤0.02. In the formula (II), x2 may be 0.65≤x2≤1.0, or may be 0.70≤x2≤0.90, or may be 0.75≤x2≤0.85. In the formula (II), y2 may be 0<y2≤0.3, or may be 0.01≤y2≤0.2, or may be 0.05≤y2≤0.15. In the formula (II), z2 may be 0<z2≤0.3, or may be 0.01≤z2≤0.2, or may be 0.05≤z2≤0.15. The composition of the second active material can be determined by ICP (high-frequency Inductively Coupled Plasma) emission spectroscopy, for example.

The second active material may include two or more lithium-(transition metal) composite oxides that are different in composition, within the range of the composition represented by the formula (II). The second active material may include two or more lithium-(transition metal) composite oxides that are different in at least one of particle shape and particle size.

First layer 11 is simply required to be mainly composed of the first active material. “Being mainly composed of the first active material” refers to including the first active material in a content of 50 weight % or more relative to the total weight of first layer 11. The content of the first active material in first layer 11 may be 60 weight % or more, or may be 70 weight % or more, or may be 80 weight % or more, or may be from 50 to 99 weight %, or may be from 60 to 98 weight %, or may be from 70 to 95 weight %, or may be from 80 to 92 weight %. First layer 11 may include a positive electrode active material other than the first active material, and, for example, it may include the second active material, or it may include a positive electrode active material other than the first active material and the second active material. First layer 11 can further include at least one of a conductive aid and a binder.

Second layer 12 is simply required to be mainly composed of the second active material. “Being mainly composed of the second active material” refers to including the second active material in a content of 50 weight % or more relative to the total weight of second layer 12. The content of the second active material in second layer 12 may be 60 weight % or more, or may be 70 weight % or more, or may be 80 weight % or more, or may be from 50 to 99 weight %, or may be from 60 to 98 weight %, or may be from 70 to 95 weight %, or may be from 80 to 92 weight %. Second layer 12 may include a positive electrode active material other than the second active material, and, for example, it may include the first active material, or it may include a positive electrode active material other than the second active material and the first active material. Second layer 12 may further include at least one of a conductive aid and a binder.

The porosity of first layer 11 and the porosity of second layer 12 are independently 22% or less, preferably 20% or less, and they may be less than 20%, or may be from 10 to 22%, or may be from 12 to 21%, or may be from 15 to 20%, or may be not less than 15% and less than 20%. The porosity of first layer 11 and the porosity of second layer 12 may be the same as or different from one another. The porosity of first layer 11 may be either more than or less than the porosity of second layer 12. When the porosity of first layer 11 and the porosity of second layer 12 both fall within the above-mentioned ranges, the secondary battery tends to have high capacity. The porosity of the first layer and the porosity of the second layer can be determined by image analysis of a cross-sectional image of positive electrode plate 1 captured with a scanning electron microscope (SEM).

The thickness of first layer 11 is smaller than the thickness of second layer 12. In the secondary battery, when first layer 11 is thick, first layer 11 tends to come into contact with the electrolyte solution on a side of active material layer 10 opposite to the current collector, but it tends not to come into contact with the electrolyte solution on the current collector side. In contrast, when first layer 11 is thin, the entire first layer 11 tends to come into contact with the electrolyte solution, and the electrolyte solution tends to reach the second layer 12. As a result, the reaction tends to occur throughout the entire first layer 11 during charging of the secondary battery and, thereby, the reaction tends to proceed throughout the entire active material layer 10, so quick-charge performance of the secondary battery can be enhanced.

The thickness ratio of first layer 11 to the second layer, (first layer):(second layer), is preferably from 0.8:9.2 to 4.5:5.5, more preferably from 1:9 to 4:6; it may be from 1:9 to 3.5:6.5; it is further preferably from 1:9 to 3:7; and it may be from 1.5:8.5 to 2.5:7.5. When the thickness ratio falls within the above-mentioned range, quick-charge performance of the secondary battery can be further enhanced.

The thickness of active material layer 10 is from 10 to 200 μm, for example, preferably from 30 to 200 μm, and it may be from 50 to 180 μm or may be from 60 to 150 μm. The thickness of first layer 11 is from 5 to 100 μm, for example, preferably from 15 to 100 μm, and it may be from 5 to 80 μm, or may be from 7 to 60 μm, or may be from 10 to 59 μm. The thickness of second layer 12 is from 7 to 180 μm, for example, preferably from 20 to 180 μm, and it may be from 20 to 150 μm, or may be from 30 to 120 μm, or may be from 50 to 100 μm.

Each of the porosities of first layer 11 and second layer 12, the thickness ratio of the first layer 11 to the second layer, and the thicknesses of active material layer 10, first layer 11, and second layer 12 described above can be regulated by changing the amount of the first active material and the second active material to apply for forming active material layer 10, the rate of application, the pressing pressure and the number of pressing operation at the time of rolling a coating layer formed by application of the first active material and the second active material, the particle properties (the particle size, in particular) of the first active material and the second active material, the mixing ratio of particles that are different in particle size and/or particle shape, the content of the conductive aid and the binder in first layer 11 and second layer 12, or the like.

The ratio of the first active material in first layer 11 relative to the total of the first active material in active material layer 10 is preferably from 80 to 100 weight %, more preferably from 90 to 100 weight %, and it may be from 95 to 99 weight %. The ratio of the second active material in second layer 12 relative to the total of the second active material in active material layer 10 is preferably from 80 to 100 weight %, more preferably from 90 to 100 weight %, and it may be from 95 to 99 weight %. This means that a relatively great amount of the first active material may be positioned at a side of active material layer 10 opposite to the current collector and a relatively great amount of the second active material may be positioned at the current collector side of active material layer 10, and, as a result, quick-charge performance of the secondary battery tends to be enhanced.

Active material layer 10 includes at least first layer 11 and second layer 12. In active material layer 10, first layer 11 constitutes a side of active material layer 10 opposite to the current collector, a side that is farther from the current collector than second layer 12 is, and second layer 12 constitutes a side of active material layer 10 closer to the current collector than first layer 11 is. Preferably, first layer 11 constitutes a surface of active material layer 10 on a side opposite to the side on which current collector 15 is positioned (namely, a side of active material layer 10 opposite to the current collector). Preferably, second layer 12 is in contact with current collector 15. As a result, in the secondary battery, the first active material tends to come into contact with the electrolyte solution and the second active material tends to come into contact with current collector 15, so quick-charge performance of the secondary battery tends to be enhanced.

Active material layer 10 may have a double-layer structure consisting of first layer 11 and second layer 12, or may have a multilayer structure consisting of three or more layers including another layer other than first layer 11 and second layer 12 (hereinafter, this another layer is also called “an additional layer”). The position of the additional layer in active material layer 10 is not particularly limited, and it may be determined according to the type, content, and the like of the positive electrode active material included in the additional layer. For example, when the additional layer includes the first active material and/or the second active material, the positions of the first layer, the second layer, and the additional layer may be adjusted so that the content of the first active material decreases, or the content of the second active material increases, gradually from a surface of active material layer 10 opposite to current collector 15 toward the current collector 15 side.

Examples of the conductive aid that may be included in active material layer 10, first layer 11, or second layer 12 include a carbon material. The carbon material may be fibrous carbon, graphite, and the like, for example. The graphite may be one or more selected from the group consisting of carbon black (such as acetylene black, Ketjenblack), coke, and activated carbon. The fibrous carbon may be carbon nanotubes (CNTs), for example. The CNTs may be single-walled carbon nanotubes (SWCNTs), or may be multi-walled carbon nanotubes such as double-walled carbon nanotubes (DWCNTs). The conductive aid can include one, two, or more of the above-mentioned conductive aids.

Examples of the binder that may be included in active material layer 10, first layer 11, or second layer 12 include known materials such as, for example, fluororesins such as polyvinylidene difluoride (PVdF) and polytetrafluoroethylene (PTFE); cellulose-based resins such as carboxymethylcellulose (CMC), methylcellulose (MC), and hydroxypropylcellulose; and styrene-butadiene rubber (SBR). The binder can include one, two, or more of the above-mentioned binders.

Positive electrode plate 1 can be produced by, for example, forming second layer 12 and first layer 11 in this order on current collector 15. For example, a second slurry including the second active material is applied to current collector 15, and dried, and thereby a second coating layer is formed. Then, a first slurry including the first active material is applied to the second coating layer, and dried, and thereby a first coating layer is formed. The second coating layer and the first coating layer thus formed sequentially on current collector 15 are compressed, and thereby positive electrode plate 1 can be obtained. The first slurry and the second slurry can include a conductive aid, a binder, and a solvent such as N-methyl-2-pyrrolidone (NMP), in addition to the above-mentioned positive electrode active material.

### (Non-Aqueous Electrolyte Secondary Battery)

A non-aqueous electrolyte secondary battery according to the present embodiment (hereinafter also called “the present battery”) has positive electrode plate 1. As described above, positive electrode plate 1 has active material layer 10 that includes first layer 11 and second layer 12. Having positive electrode plate 1, the present battery has excellent quick-charge performance.

The present battery can include an electrode assembly including positive electrode plate 1, as well as a non-aqueous electrolyte solution, and it may also have a battery case for accommodating the electrode assembly and the non-aqueous electrolyte solution. The battery case may include an exterior package having an opening, and a sealing plate for sealing the opening. The exterior package and the sealing plate are preferably made of metal, and can be formed with aluminum, aluminum alloy, iron, iron alloy, or the like. Between the electrode assembly and the exterior package, a resin sheet may be provided as an electrode holder. The battery case may be made of a laminated film. The laminated film has a multilayer structure formed of a metal layer and a resin layer stacked on top of one another, for example. The edges of the laminated film can be fused together to form a pouch-shaped battery case.

The electrode assembly may include positive electrode plate 1, a negative electrode plate, and a separator. In the electrode assembly, active material layer 10 of positive electrode plate 1 faces a negative electrode active material layer of the negative electrode plate, with the separator interposed therebetween. The electrode assembly may be a stack-type one that is formed by stacking positive electrode plate 1, the negative electrode plate, and the separator, or may be a wound-type one that is formed by stacking positive electrode plate 1, the negative electrode plate, and the separator and winding the resulting stack. After the stack is wound, the wound-type electrode assembly may be pressed into a flat shape.

The negative electrode plate usually has a negative electrode current collector and a negative electrode active material layer, and the negative electrode current collector is, for example, a metal foil sheet made of a copper material such as copper and copper alloy. The negative electrode active material layer includes a negative electrode active material, and it may further include a conductive aid, a binder, and the like.

Examples of the negative electrode active material include carbon-based active material particles, metal-based active material particles, and the like. Examples of the carbon-based active material particles include particles of one or more types of carbon material selected from the group consisting of graphite such as natural graphite and artificial graphite, hard carbon, soft carbon, and amorphous-coated graphite. Examples of the metal-based active material particles include particles of a metallic element such as an elemental metal or a metal oxide including an element selected from the group consisting of silicon (Si), tin (Sn), antimony (Sb), bismuth (Bi), titanium (Ti), and germanium (Ge). Preferably, examples of the metal-based active material particles include particles of one or more types selected from the group consisting of Si, SiOx (x=0.5 to 1.5), a Si—C composite (hereinafter also called “a SiC composite”), and Sn.

Examples of the conductive aid include the conductive aids described above as the conductive aid that may be included in active material layer 10. The conductive aid can include one, two, or more of the above-mentioned conductive aids. Examples of the binder include the cellulose-based resins that are described above as the binder that may be included in active material layer 10; polyacrylic acid; styrene-butadiene rubber (SBR); and the like. The binder can include one, two, or more of the above-mentioned binders.

The negative electrode plate can be obtained by, for example, forming the negative electrode active material layer on the negative electrode current collector. For example, a negative electrode composite material slurry including the negative electrode active material is applied to the negative electrode current collector, and dried and compressed, and thereby a negative electrode plate is obtained. The negative electrode composite material slurry can include a conductive aid, a binder, and a solvent such as water, in addition to the above-mentioned negative electrode active material.

The separator has a base material, and it may have a functional layer on at least one side of the base material. The base material can be a porous sheet such as a film or a nonwoven fabric, which is made of a resin such as polyolefin (such as polyethylene and polypropylene), polyester, cellulose, polyamide, and/or the like. The base material may have a monolayer structure, or may have a multilayer structure. Examples of the functional layer include an adhesive layer and a heat-resistant layer, and the functional layer can be either one of them, or both. The adhesive layer can be formed with an adhesive agent, for example. The heat-resistant layer can include a filler and a binder, for example.

The non-aqueous electrolyte solution is preferably obtained by adding an electrolyte to a non-aqueous solvent such as an organic solvent. Examples of the electrolyte include LiPF₆, LiBF₄, LiClO₄, LiFSO₃, LiBOB (lithium bis(oxalato) borate), and the like. The non-aqueous electrolyte solution may include one, two, or more electrolytes among these. Examples of the non-aqueous solvent include ethylene carbonate (EC), ethyl methyl carbonate (EMC), dimethyl carbonate (DMC), propylene carbonate (PC), butylene carbonate (BC), diethyl carbonate (DEC), and the like. The non-aqueous electrolyte solution can include one, two, or more non-aqueous solvents among these. The non-aqueous electrolyte solution may further include an additive such as vinylene carbonate (VC), vinylethylene carbonate (VEC), and fluoroethylene carbonate.

### EXAMPLES

In the following, the present disclosure will be described in further detail by way of Example, Comparative Examples, and Reference Examples.

### Example 1

### (Preparation of Positive Electrode Plate)

Li_{1.14}Ni_{0.29}Mn_{0.57}O₂ as a first active material, graphite as a conductive aid, and polyvinylidene difluoride (PVdF) powder as a binder were prepared in a weight ratio of (first active material):graphite:PVdF=100:1:1, and these were mixed with a proper amount of N-methyl-2-pyrrolidone (NMP) to obtain a first slurry.

LiNi_{0.8}Co_{0.1}Mn_{0.1}O₂ as a second active material, graphite as a conductive aid, and polyvinylidene difluoride (PVdF) powder as a binder were prepared in a weight ratio of (second active material):graphite:PVdF=100:1:1, and these were mixed with a proper amount of N-methyl-2-pyrrolidone (NMP) to obtain a second slurry.

The second slurry was applied to both sides of an aluminum foil sheet as a current collector, and dried, to form a second coating layer. Subsequently, the first slurry was applied to the second coating layer, and dried, to form a first coating layer. The coating thickness of the second slurry and the first slurry, (Coating thickness of second slurry):(Coating thickness of first slurry), was 7:3. The second coating layer and the first coating layer thus formed on the current collector were rolled with a roller, and thereby a layer (2) was formed from the second coating layer and a layer (1) was formed from the first coating layer, and thus a positive electrode plate was obtained. The positive electrode plate has the active material layer on both sides of the current collector, and the active material layer has a double-layer structure that has the layer (2) and the layer (1) in this order from the current collector side.

### (Preparation of Test Battery)

The positive electrode plate obtained in the above-mentioned manner, a negative electrode plate as a counter electrode for the positive electrode plate, a separator, and the like were used to prepare a test battery.

### Comparative Examples 1, 5, 6, Reference Examples 1 and 3

The second slurry prepared in the procedure described in Example 1 was applied to an aluminum foil sheet as a current collector, and dried and rolled, to obtain a positive electrode plate. In each Comparative Example and Reference Example, the coating thickness of the second slurry was adjusted so as to achieve the porosity described below. The positive electrode plate has a single layer of active material layer on the current collector, and this active material layer contains a second active material. The positive electrode plate thus obtained was used to prepare a test battery.

### Comparative Example 2

In the procedure described in Example 1, the first slurry and the second slurry were prepared. The first slurry was applied to an aluminum foil sheet as a current collector, and dried, to form a first coating layer. Subsequently, the second slurry was applied to the first coating layer, and dried, to form a second coating layer. The coating thickness of the first slurry and the second slurry, (Coating thickness of first slurry):(Coating thickness of second slurry), was 3:7. The first coating layer and the second coating layer thus formed on the current collector were rolled with a roller, and thereby a layer (1) was formed from the first coating layer and a layer (2) was formed from the second coating layer, and thus a positive electrode plate was obtained. The positive electrode plate has the active material layer on the current collector, and the active material layer has a double-layer structure that has the layer (1) and the layer (2) in this order from the current collector side.

### Comparative Examples 3

The first slurry prepared in the procedure described in Example 1 was applied to an aluminum foil sheet as a current collector, and dried and rolled, to obtain a positive electrode plate. The positive electrode plate has a single layer of active material layer on the current collector, and this active material layer contains a first active material. The positive electrode plate thus obtained was used to prepare a test battery.

### Comparative Example 4, Examples 2 to 6, Reference Examples 2 and 4

A positive electrode plate and a test battery were prepared in the procedure described in Example 1 except that the coating thickness of the first slurry and the second slurry was adjusted so as to achieve the porosity and the thickness ratio of the layer (1) to the layer (2) described below.

### [Measurement of Thickness Ratio, and Measurement of Porosity]

The positive electrode plate was cut in the thickness direction, and in the resulting cross section, a scanning electron microscope (SEM) image of the active material layer was captured. In the SEM image thus captured, the thickness of the layer (1) and the layer (2) was determined, and the thickness ratio was calculated. Results are given in Table 1.

The SEM image thus captured was analyzed to calculate the porosity of the layer (1) and the layer (2) by the following equation.

Porosity [%]=[1−{((Content ratio of active material)/(True density of active material))+((Content ratio of conductive aid)/(True density of conductive aid))+((Content ratio of binder)/(True density of binder))}×(Weight of active material layer per unit area)}]/(Volume of active material layer per unit area)

In the above equation, the content ratios of the active material, the conductive material, and the binder are the contents [mass %] of the active material, the conductive material, and the binder, respectively, relative to the total amount of the active material layer. Results are given in Table 1.

### [Evaluation of Quick-Charge Performance]

The state of charge of the test battery is made to be an SOC of 0% (3.0 V). At a rate of 2 C, constant-current charging (CC charging) is performed to reach an SOC of 100% (4.2 V). After the cutoff voltage was reached and the charging was completed, followed by 30 minutes of resting, the voltage of the test battery was measured. The value of SOC corresponding to this voltage was calculated, and the resulting value was regarded as the SOC reached by charging at a rate of 2 C. Results are given in Table 1.

TABLE 1

| | Active material layer | | | | | | | |
|---|---|---|---|---|---|---|---|---|
| | | Type of active | | | | | | |
| | | material | | | | Porosity [%] | | SOC |
| | | Opposite | | | | Opposite | | reached |
| | | side to | Current | | | side to | Current | by |
| | | current | collector | Thickness | Thickness | current | collector | charging |
| | Structure | collector | side | [μm] | ratio*¹ | collector | side | [%] |
| Comp. | Monolayer | Second active | | 106 | — | 19.5 | | 44 |
| Ex. 1 | | material | | | | | | |
| Ex. 1 | Double | First | Second | 108 | 2/8 | 19.8 | 19.3 | 49 |
| | layer | active | active | | | | | |
| | | material | material | | | | | |
| Comp. | Double | Second | First | 106 | 8/2 | 19.2 | 19.6 | 44 |
| Ex. 2 | layer | active | active | | | | | |
| | | material | material | | | | | |
| Comp. | Monolayer | First active | | 107 | — | 19.8 | | 40 |
| Ex. 3 | | material | | | | | | |
| Ex. 2 | Double | First | Second | 108 | 3/7 | 19.7 | 19.4 | 47 |
| | layer | active | active | | | | | |
| | | material | material | | | | | |
| Ex. 3 | Double | First | Second | 109 | 1/9 | 19.9 | 19.3 | 48 |
| | layer | active | active | | | | | |
| | | material | material | | | | | |
| Ex. 4 | Double | First | Second | 108 | 4/6 | 19.7 | 19.5 | 46 |
| | layer | active | active | | | | | |
| | | material | material | | | | | |
| Comp. | Double | First | Second | 109 | 5/5 | 19.6 | 19.5 | 44 |
| Ex. 4 | layer | active | active | | | | | |
| | | material | material | | | | | |
| Comp. | Monolayer | Second active | | 107 | — | 18.7 | | 41 |
| Ex. 5 | | material | | | | | | |
| Ex. 5 | Double | First | Second | 106 | 2/8 | 18.9 | 18.6 | 47 |
| | layer | active | active | | | | | |
| | | material | material | | | | | |
| Comp. | Monolayer | Second active | | 105 | — | 16.5 | | 39 |
| Ex. 6 | | material | | | | | | |
| Ex. 6 | Double | First | Second | 103 | 2/8 | 16.8 | 16.4 | 44 |
| | layer | active | active | | | | | |
| | | material | material | | | | | |
| Ref. | Monolayer | Second active | | 107 | — | 23.2 | | 48 |
| Ex. 1 | | material | | | | | | |
| Ref. | Double | First | Second | 106 | 2/8 | 23.5 | 23.1 | 49 |
| Ex. 2 | layer | active | active | | | | | |
| | | material | material | | | | | |
| Ref. | Monolayer | Second active | | 108 | — | 25.5 | | 51 |
| Ex. 3 | | material | | | | | | |
| Ref. | Double | First | Second | 103 | 2/8 | 25.8 | 25.2 | 50 |
| Ex. 4 | layer | active | active | | | | | |
| | | material | material | | | | | |

*¹(Thickness [μm] of opposite side to current collector)/(Thickness [μm] of current collector side)

From the comparison of Example 1 with Comparative Examples 1 to 3, it is indicated that when the active material layer has a double-layer structure in which the layer (1) mainly composed of the first active material is positioned on the opposite side to the current collector and the layer (2) mainly composed of the second active material is positioned on the current collector side, a secondary battery with excellent quick-charge performance is obtained. From the comparison of Examples 1 to 4 with Comparative Example 4, it is indicated that when the thickness of the layer (1) on the opposite side to the current collector is smaller than the thickness of the layer (2) on the current collector side, a secondary battery with excellent quick-charge performance is obtained. From the results of Examples 1 to 6 and Comparative Examples 1, 3, 5, and 6, it is indicated that when the porosity of the active material layer is 22% or less and the active material layer has a double-layer structure, good quick-charge performance is obtained as compared to a monolayer structure. From the results of Reference Examples 1 to 4, it is indicated that when the porosity of the active material layer exceeds 22%, regardless of whether the active material layer has a monolayer structure or a double-layer structure, good quick-charge performance is obtained. From these, it is indicated that when the porosity of the active material layer is 22% or less and when its structure is a double-layer structure that has the second layer (the layer (2)) and the first layer (the layer (1)) in this order from the current collector side, quick-charge performance can be enhanced.

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A positive electrode plate comprising:
a current collector; and
an active material layer provided on the current collector, wherein
the active material layer has
a first layer mainly composed of a first active material represented by a formula (I) below, and
a second layer that is positioned closer to the current collector than the first layer is and that is mainly composed of a second active material represented by a formula (II) below,
a porosity of the first layer and a porosity of the second layer are both 22% or less, and
a thickness of the first layer is smaller than a thickness of the second layer:
Li(Liₐ₁Niₓ₁Mn_{y1}M1_{z1})O₂ (I)
Li(Liₐ₂Niₓ₂Mn_{y2}M2_{z2})O₂ (II)
where
M1 and M2 are independently one or more metallic elements selected from the group consisting of Co, Al, Mg, Ca, Ti, V, Cr, Fe, Cu, Zn, Zr, Nb, Mo, Ta, and W,
0.1≤a1≤0.33, 0≤x1≤0.5, 0.5≤y1≤0.7, 0≤z1≤0.2, and a1+x1+y1+z1=1 are satisfied, and
−0.1≤a2≤0.1, 0.6≤x2≤1, 0≤y2≤0.3, 0≤z2≤0.3, and a2+x2+y2+z2=1 are satisfied.

2. The positive electrode plate according to claim 1, wherein a thickness ratio of the first layer to the second layer is (first layer):(second layer)=0.8:9.2 to 4.5:5.5.

3. The positive electrode plate according to claim 1, wherein a thickness ratio of the first layer to the second layer is (first layer):(second layer)=1:9 to 3.5:6.5.

4. The positive electrode plate according to claim 1, wherein a thickness of the active material layer is from 10 to 200 μm.

5. The positive electrode plate according to claim 1, wherein the porosity of the first layer and the porosity of the second layer are both 10 to 22%.

6. The positive electrode plate according to claim 1, wherein the first layer constitutes a surface of the active material layer on a side opposite to a side on which the current collector is positioned.

7. The positive electrode plate according to claim 1, wherein the second layer is in contact with the current collector.

8. A non-aqueous electrolyte secondary battery comprising the positive electrode plate according to claim 1.
